(19) United States
(12) Patent Application Publication
(10) Pub. No.: US 2026/0239053 A1
(43) Pub. Date: Aug. 13, 2026

(54) EXPOSING LINK DELAY PERFORMANCE EVENTS FOR A TETHERED CONNECTION IN A WIRELESS COMMUNICATION NETWORK

(71) Applicant: Lenovo (Singapore) Pte. Limited, Singapore (SG)

(72) Inventors: Razvan-Andrei Stoica, Essen (DE); Dimitrios Karampatsis, Ruislip (GB); Emmanouil Pateromichelakis, Viersen (DE)

(73) Assignee: Lenovo (Singapore) Pte. Limited, Singapore (SG)

(21) Appl. No.: 19/160,561

(22) PCT Filed: Apr. 19, 2023
(86) PCT No.: PCT/EP2023/060184

§ 371 Date: Aug. 28, 2025

(30) Foreign Application Priority Data
Mar. 3, 2023 (GR) 20230100188

(51) Int. Cl. H04W 24/08; H04L 43/10

(52) U.S. Cl. CPC H04W 24/08; H04L 43/10

(57) ABSTRACT

There is provided herein a method performed by a data collection application function, the method for exposure of link delay performance events for an application experienced via a tethered connection between a first device and a second device, the method comprising; receiving a configuration for a data access profile for data collection, the data concerning a link delay in the tethered connection; and applying the data access profile a data access profile 1210 to at least one data collection client. The method further comprises: receiving collected link delay measurements from the at least one data collection client; processing the link delay measurements based in part on the data access profile to produce one or more link delay performance events; and exposing the one or more link delay performance events corresponding to the application experienced via the tethered connection.

### FIELD

The subject matter disclosed herein relates generally to the field of exposing link delay performance events for a tethered connection in a wireless communication network. This document defines a data collection application function, a method performed by a data collection application function, a data collection client, and a method performed by a data collection client.

### INTRODUCTION

In many interactive and immersive applications with challenging requirements on latency, rate and reliability, the application experience is served over a tethered connection whereby an endpoint Personal IoT Network Element (PINE) device is connected to a gateway device which in turn is connected to a 3GPP access network (e.g., 4G, 5G or alike) for Internet connectivity. Examples of such application experience delivery include, for instance, AR/VR experiences where the PINE is a head-mounted device (HMD) in the form of AR/VR glasses and the gateway is a mobile phone, or alternatively, 3GPP user equipment (UE). The E2E connectivity between a client and an application server relies therefore on at least three heterogeneous network segments, i.e., the tethered link, the 3GPP connectivity, and the data network (DN) link. The tethered and DN links are out of scope of 3GPP. The tethering connection between the PINE and the gateway relies usually on Wi-Fi, Bluetooth, or unlicensed spectrum radio access technologies. Such a connection affects the E2E QoS and in effect both the tethered link and the DN link contribute in such a way as to reduce the effectiveness of QoS rules and policies employed within the 3GPP network.

### SUMMARY

There is need for 3GPP networks to monitor and ingest link metrics regarding the performance of out-of-scope network segments (e.g., tether link, DN link) across a heterogeneous E2E network path. A 3GPP network may also perform analytics of such link metrics and derive statistical characterizations of the expected performance. Further such a 3GPP network may adapt the 3GPP QoS rules and policies and compensate for out-of-scope network segments degrading effects (e.g., additional latency etc.) and seamlessly satisfy E2E applications requirements for an enhanced user experience.

Disclosed herein are procedures for exposing link delay performance events for a tethered connection in a wireless communication network. Said procedures may be implemented by a data collection application function, a method performed by a data collection application function, a data collection client, and a method performed by a data collection client.

Accordingly, there is provided a data collection application function for exposure of link delay performance events for an application experienced via a tethered connection between a first device and a second device. The data collection application function comprises a processor; and a memory coupled with the processor. The processor is configured to cause the data collection application function to: receive a configuration for a data access profile for data collection, the data concerning a link delay in the tethered connection; apply the data access profile to at least one data collection client; receive collected link delay measurements from the at least one data collection client; process the link delay measurements based in part on the data access profile to produce one or more link delay performance events; and expose the one or more link delay performance events corresponding to the application experienced via the tethered connection.

There is further provided a method performed by a data collection application function, the method for exposure of link delay performance events for an application experienced via a tethered connection between a first device and a second device, the method comprising; receiving a configuration for a data access profile for data collection, the data concerning a link delay in the tethered connection; and applying the data access profile to at least one data collection client. The method further comprises: receiving collected link delay measurements from the at least one data collection client; processing the link delay measurements based in part on the data access profile to produce one or more link delay performance events; and exposing the one or more link delay performance events corresponding to the application experienced via the tethered connection.

There is further provided a data collection client for exposure of link delay performance events for an application experienced via a tethered connection between a first device and a second device. The data collection client comprises a processor; and a memory coupled with the processor. The processor is configured to cause the apparatus to: receive a data access profile from a data collection application function; collect link delay measurements in accordance with the received data access profile; and send collected link delay measurements to the data collection application function.

There is further still provided a method performed by a data collection client, the method for exposure of link delay performance events for an application experienced via a tethered connection between a first device and a second device. The method comprises: receiving a data access profile from a data collection application function; collecting link delay measurements in accordance with the received data access profile; and sending collected link delay measurements to the data collection application function.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for exposing link delay performance events for a tethered connection in a wireless communication network will now be described, by way of example only, with reference to the accompanying drawings, in which:

FIG. 1 depicts an embodiment of a wireless communication system for exposing link delay performance events for a tethered connection in a wireless communication network;

FIG. 2 depicts a user equipment apparatus that may be used for implementing the methods described herein;

FIG. 3 depicts further details of the network node that may be used for implementing the methods described herein;

FIG. 4 which illustrates an overview of a core network XRM architecture handling data packets;

FIG. 5 depicts an implementation of a first tethering approach as tethered standalone glasses;

FIG. 6 illustrates an implementation of AR glasses whereby an XR tethered link exposes an XR runtime to 5G or alike Device as an XR runtime API;

FIG. 7 illustrates an implementation of AR glasses whereby exposure of the XR runtime via the tethering link as media buffer source and sink is supported by a virtualized edge network XR runtime instance;

FIG. 8 illustrates an E2E path and subsequent path delays;

FIG. 9 illustrates an example wireless communication system;

FIG. 10 illustrates a generic DCAF architecture depicted in simplified format;

FIG. 11 illustrates a method of a tethered application DCAF for the data collection and reporting of non-3GPP link delays;

FIG. 12 illustrates a method performed by a data collection application function; and

FIG. 13 illustrates a method performed by a data collection client.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

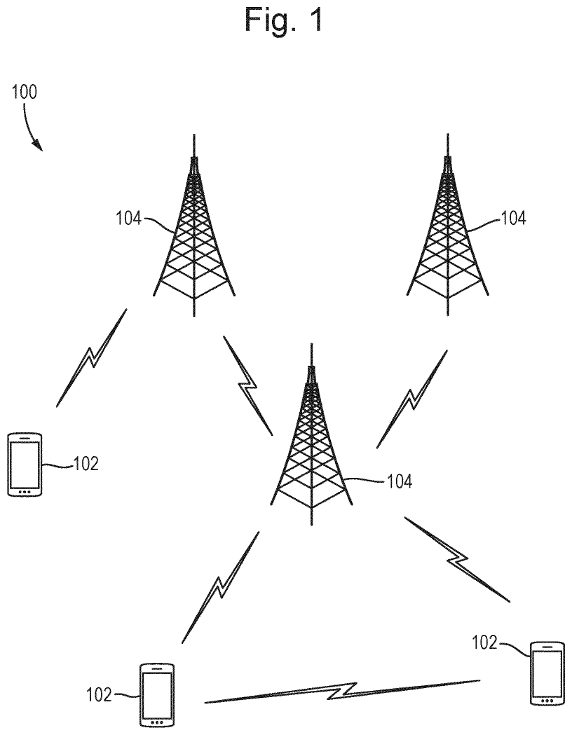

FIG. 1 depicts an embodiment of a wireless communication system 100 for exposing link delay performance events for a tethered connection in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

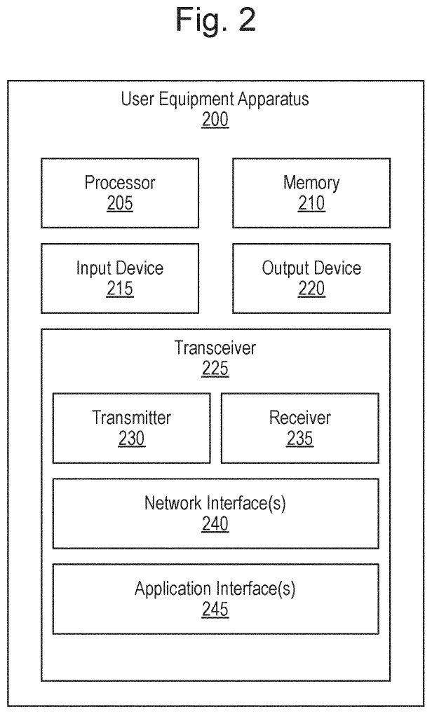

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a UE 435, 904, a 5G device 530, 630, 730, or a tethered UE 1110 as described herein. The user equipment apparatus 200 may include a data collection client as defined herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller.

The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

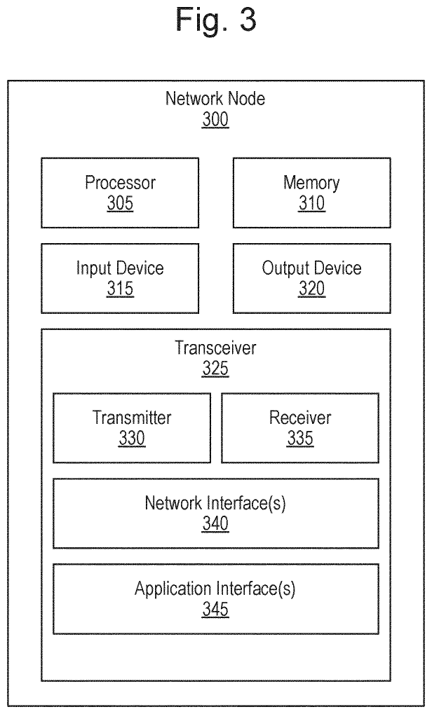

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a network unit 104, a RAN 430, or a 5G core 1120 as described herein. The network node 300 may include a data collection application function as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound.

For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In many interactive and immersive applications with challenging requirements on latency, rate and reliability, the application experience is served over a tethered connection whereby an endpoint Personal IoT Network Element (PINE) device is connected to a gateway device which in turn is connected to a 3GPP access network (e.g., 4G, 5G or alike) for Internet connectivity. Examples of such application experience delivery include, for instance, AR/VR experiences where the PINE is a head-mounted device (HMD) in the form of AR/VR glasses and the gateway is a mobile phone, or alternatively, 3GPP user equipment (UE). The E2E connectivity between a client and an application server relies therefore on at least three heterogeneous network segments, i.e., the tethered link, the 3GPP connectivity, and the data network (DN) link. The tethered and DN links are out of scope of 3GPP. The tethering connection between the PINE and the gateway relies usually on Wi-Fi, Bluetooth, or unlicensed spectrum radio access technologies. Such a connection affects the E2E QoS and in effect both the tethered link and the DN link contribute in such a way as to reduce the effectiveness of QoS rules and policies employed within the 3GPP network.

As such, it is of high importance for 3GPP networks to monitor and ingest link metrics regarding the performance of out-of-scope network segments (e.g., tether link, DN link) across a heterogeneous E2E network path. A 3GPP network may also perform analytics of such link metrics and derive statistical characterizations of the expected performance. Further such a 3GPP network may adapt the 3GPP QoS rules and policies and compensate for out-of-scope network segments degrading effects (e.g., additional latency etc.) and seamlessly satisfy E2E applications requirements for an enhanced user experience.

There are presented herein example solutions in the context of latency for AR/VR applications, or collectively, XR applications. However, the mechanisms and procedure described herein expand beyond XR applications and are equally applicable also to other applications served over tethered links.

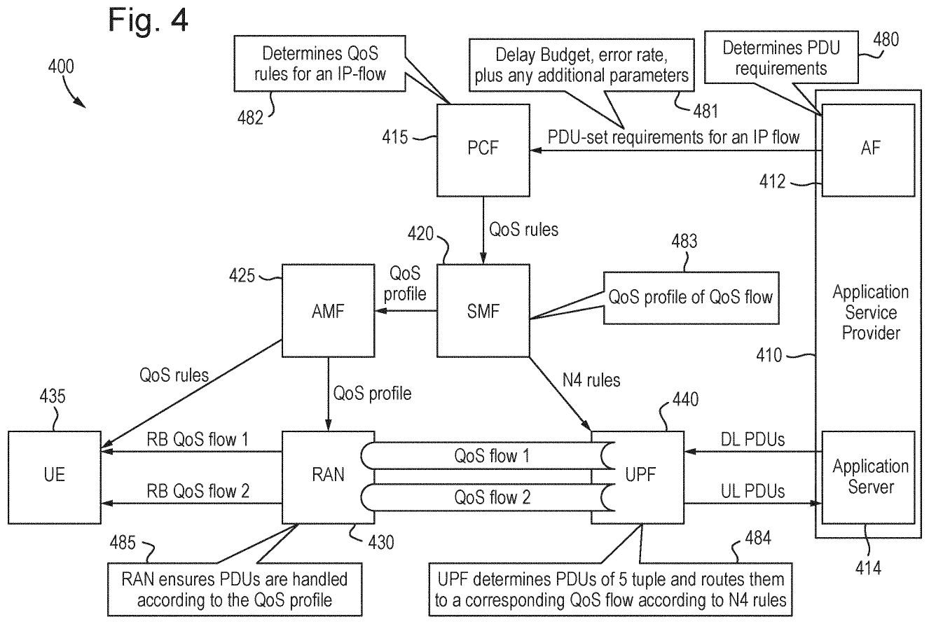

The core network handles packets, which may be Protocol Data Units (PDUs), and which may be grouped into PDU-sets, as shown in FIG. 4, which illustrates an overview of a core network (CN) XRM architecture handling data packets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN 430, a User Equipment (UE) 435, a User Plane Function (UPF) 440, and an Application Service Provider 410. The Application Service Provider 410 comprises an Application Function (AF) 412 and an Application Server 414. The UE 435 may comprise a remote unit 102 or a user equipment apparatus 200 as described herein. The RAN 430 may comprise a base unit 104, a network node 300 as described herein. The operation of system 400 will now be described in the example of downlink traffic, a similar process may operate for uplink traffic.

At 480, the AF 412 determines PDU requirements.

At 481, the Application Function 412 provides QoS requirements for packets to the PCF 415 and information to identify the application (i.e. 5-tuple or application id). The QoS requirements may be expressed in terms of delay budget, Packet Delay Budget (PDF), or alternatively, PDU Set Delay Budget (PSDB), error rate, Packet Error Rate (PER), or alternatively, PDU Set Error Rate (PSER).

At 482, the PCF 415 determines QoS rules for the application and specific QoS requirements for the PDU. The QoS rules may use a 5G QoS identifier (5QI) for application traffic. The PCF 415 makes such a determination by determining a 5QI for the application PDU traffic. The PCF 415 sends the QoS rules to the SMF 420 as a 5-tuple PDU QoS Requirement. The PCF 415 may include in the communication to the SMF 420 Policy and Charging Control (PCC) rules per importance of a PDU. The PCC rules may be derived according to information received from the AF 412 or based on an operator configuration.

At 483, the SMF 420 establishes a QoS flow according to the QoS rules by the PCF 415 and configures the UPF to route packets of the application to a QoS flow. The SMF 420 also provides the QoS profile containing PDU QoS requirements to the RAN 430 via the AMF 425. The AMF 425 may provide the QoS profile containing PDU QoS requirements to the RAN 430 in an N2 Session Management (SM) container. Further, the AMF 425 may provide the QoS rules to the UE 435 in an N1 SM container.

At 484, the UPF 440 determines and routes the PDUs of the application (i.e., a 5 tuple) to a corresponding QoS flow, according to the N4 rules received from the SMF 420.

At 485, the RAN 430 receives QFIs, QoS profile of QoS flows from the SMF 420 via the AMF 425 during PDU session establishment/modification, identifies packets belonging to a PDU session of an application over a QoS flow and handles the packets over RBs according to the QoS requirements provided by the SMF 420. The RAN 430 inspects GTP-U headers and ensures PDUs are handled according to the determined QoS profile according to SM container. This may include transmitting some packets in a radio bearer carrying QoS flow 1. This may also include sending other packets in a different radio bearer carrying QoS flow 2.

The general steps described above regarding the QoS flow handling, RB to QoS flow to application flow mapping and PDU session handling are applicable for both UL and DL directions. That is, while the above example relates to downlink (DL) traffic, reciprocal processing is applicable to uplink (UL) traffic wherein the role of UPF 440 packet inspection is taken by the UE 435. The low-level signaling mechanism associated with the UL UE-to-RAN information passing are up to the specification and implementations of RAN signaling procedures.

Herein, eXtended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) tided “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5G System (5GS) XR QoS flows. These 5QIs are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

Tethered and Heterogeneous Links may be used for Media Applications. In Release 17, 3GPP studied the support of 5G and beyond XR glasses based on a common client architecture, relying on three major components: an XR runtime, a Scene Manager, and a Media Access Function (MAF). Out of the three of general relevance for communications aspects is the MAF.

3GPP Technical Report TR 26.998 (v18.0.0—December 2022) describes Support of 5G Glass-type AR/MR devices, and defines the Media Access Function (MAF) as supporting the AR UE to access and stream media. For this purpose, a MAF includes:
Codecs: used to compress and decompress the media. In several cases, not only a single instance of a codec per media type is needed, but multiple ones.
Content Delivery Protocols: Container format and protocol to deliver media content between the UE and the network according to the requirements of an application. This includes timing, synchronization, reliability, protocol-level reporting (e.g., RTP reporting) and other features.
5G connectivity: a modem and 5G System functionalities that allow the UE to connect to a 5G network and get access to the features and service offered by the 5G System.
Media Session Handler: A generic function on the device to setup 5G System capabilities and support 5GS integration. This may setup edge functionalities, provide QoS support, support reporting functionalities, etc.
Content protection and decryption: This function handles protection of content from being played on unauthorized devices.

Some example implementations of MAF are:
5GMSd client that includes a Media Session Handler and a Media Player as defined in TS 26.501 and TS 26.512.
5GMSu client that includes a Media Session Handler and a Media Streamer as defined in TS 26.501 and TS 26.512.
A real-time communication client that includes either uplink or downlink, or both to support more latency critical communication services, such as for XR applications.

In Release 18, 3GPP is studying further the tethering aspects for XR glass type devices whereby two different tethering approaches are established as:
Tethered standalone glasses: In this case, the glasses run an XR application that uses the capabilities of the glasses to create a service. The glasses are tethered to a 5G device or alike mobile access technology (e.g., a mobile phone) and potentially use the capabilities of the phone (e.g., Media Session Handler) to support the application.
Tethered display glasses: In this case, the glasses are tethered to a 5G device or alike mobile access technology (e.g., a mobile phone) that includes the application and the XR functions, i.e., at least the MAF and/or a lightweight scene manager instance. The 5G device runs the application that uses the capabilities of the 5G device to run an XR experience. The glasses are connected to the 5G device and embed at least a lightweight XR runtime which is exposed to the 5G device either via an XR runtime-specific API over an XR tethered link or via a wireless link exposing media buffers.

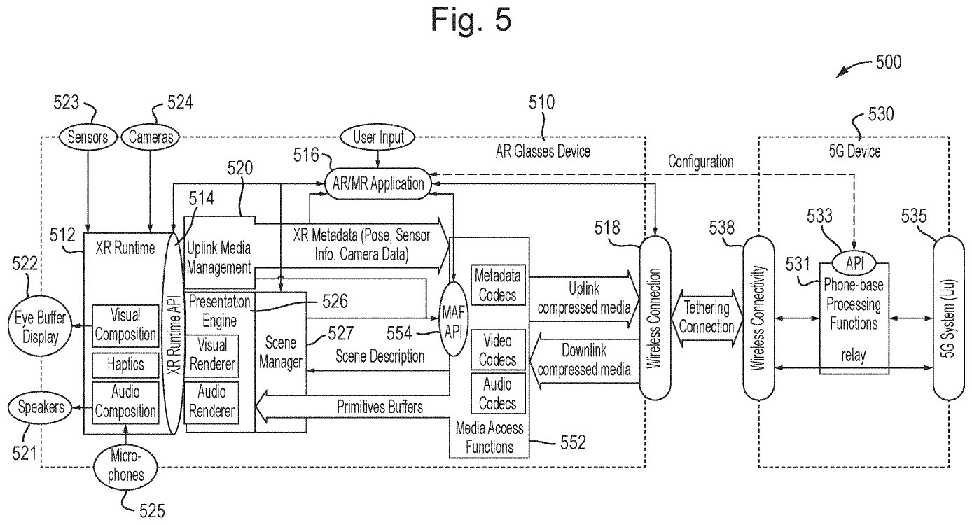

An implementation depicting the first tethering approach as tethered standalone glasses is depicted in FIG. 5. An AR glasses device 510 is tethered to a 5G Device 530. The AR glasses device 510 comprises an XR runtime 512, an XR runtime API 514, an AR/MR application 516, a wireless connection module 518, and a Media Access Function 552. A pair of speakers 521, an eye display buffer 522, sensors 523 and at least one camera 524, provide input to the XR runtime 512, which comprises visual composition, haptics and audio composition. The XR runtime API 514 provides an interface between the XR runtime 512 and each of an uplink media management module 520, and a presentation engine 526. The presentation engine 526 comprises a visual renderer and an audio renderer and interfaces with a scene manager 527. The media access function 552 comprises metadata codecs, video codecs and audio codecs and a MAF API 554. The AR/MR application 516 interfaces with each of the XR runtime API 514, the scene manager 527, and the MAF API 554.

A tethering connection is provided between the AR glasses device 510 and the 5G device 530 by respective wireless connectivity modules 518, 538. The MAF 552 passes compressed media to and from the tethered connection via the wireless connectivity module 518. 5G device 530 likely comprises a smartphone and includes a 5G system module 535. Phone based processing functions are performed by a processor 531. The phone-based processing functions comprise an API 533 which is able to pass configuration information to the AR/MR application 516 via the tethering connection.

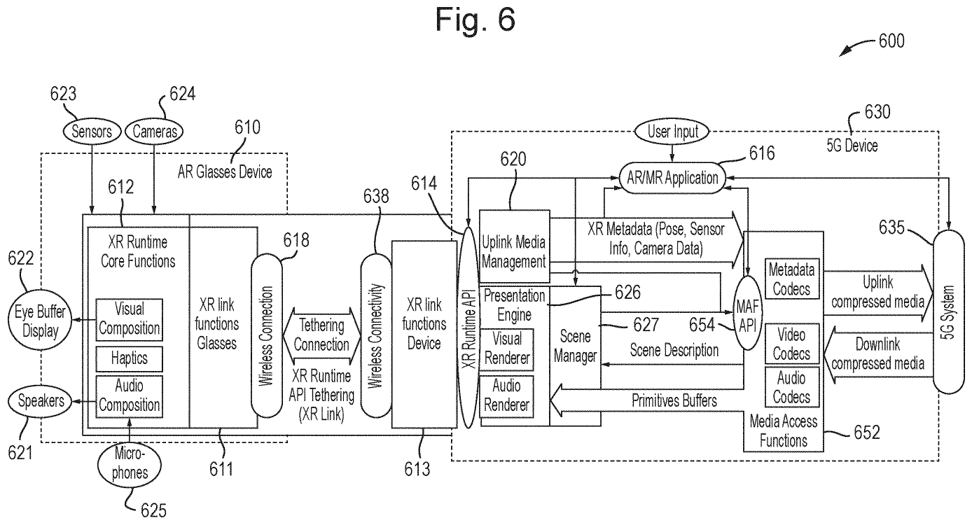

FIG. 6 illustrates an implementation of AR glasses whereby an XR tethered link exposes an XR runtime to 5G Device as an XR runtime API. An AR glasses device 610 is tethered to a 5G Device 630. The AR glasses device 610 comprises an XR runtime core functions 612. A pair of speakers 621, an eye display buffer 622, sensors 623 and at least one camera 624, provide input to the XR runtime core functions 612, which comprises visual composition, haptics and audio composition. An XR link function glasses 611 operates as an interface between the XR runtime core functions 612 and a wireless connection module 618 of the AR glasses device 610.

A tethering connection is provided between the AR glasses device 610 and the 5G device 630 by respective wireless connectivity modules 618, 638. The 5G device 630 comprises an XR link functions device 613 that provides an interface between the wireless connectivity module 638 and the XR runtime API 614. The 5G device 630 further comprises an AR/MR application 616, and a Media Access Function 652. The XR runtime API 614 provides an interface between the XR link functions device 613 and each of an uplink media management module 620, and a presentation engine 626. The presentation engine 626 comprises a visual renderer and an audio renderer and interfaces with a scene manager 627. The media access function 652 comprises metadata codecs, video codecs and audio codecs and a MAF API 654. The AR/MR application 616 interfaces with each of the XR runtime API 614, the scene manager 627, and the MAF API 654. 5G device 630 likely comprises a smartphone and includes a 5G system module 635. The MAF 652 passes compressed media to and from 5G system module 635.

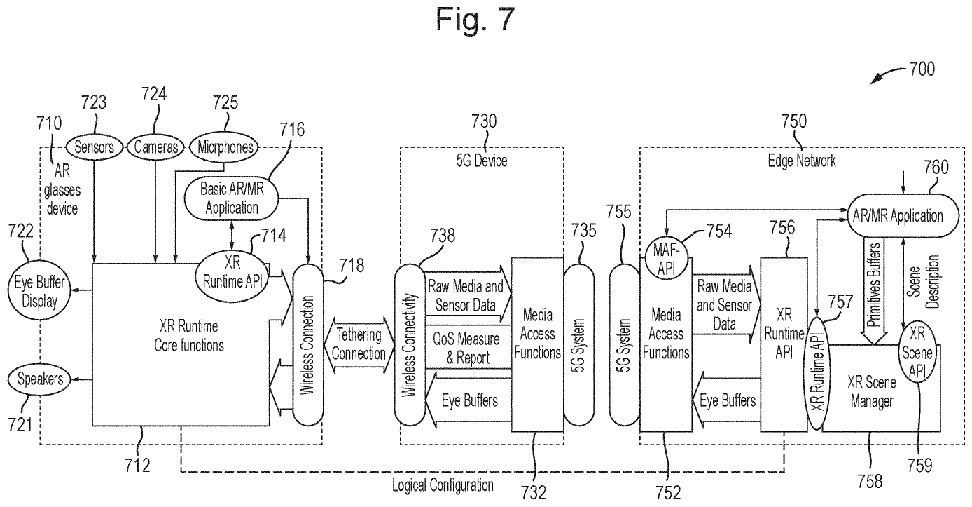

FIG. 7 illustrates an implementation of AR glasses whereby exposure of the XR runtime via the tethering link as media buffer source and sink is supported by a virtualized edge network XR runtime instance. An AR glasses device 710 is tethered to a 5G Device 730; the 5G device 730 is connected to an edge network 750 via a 5G connection. The AR glasses device 710 comprises an XR runtime core functions 712. A pair of speakers 721, an eye display buffer 722, sensors 723 and at least one camera 724, provide input to the XR runtime core functions 712. An XR runtime API 714 provides an interface to a basic AR/MR application 716.

A tethering connection is provided between the AR glasses device 710 and the 5G device 730 by respective wireless connectivity modules 718, 738. The XR runtime core functions 712 of the AR glasses device 510 exchanges data with the 5G device 730 via the tethering connection. 5G device 730 likely comprises a smartphone and includes a 5G system module 735. The 5G device 730 comprises a Media Access Function 732. The MAF 752 passes compressed media to and from 5G system module 735.

The edge network 750 comprises a media access functions 754, an XR runtime 756, an XR scene manager 758, and an AR/MR application 760. The AR/MR application 760 interfaces with the media access functions 752 via a MAF API 754, and with the XR scene manager 758 via a XR scene API 759. An XR runtime API 757 provides an interface between the XR runtime 756 and the XR scene manager 758.

All three tethering architectures of FIGS. 5, 6 and 7 can be supported by edge split-rendering to reduce the complexity, processing requirements, power consumption, and heat dissipation on the XR glasses. To this end, some key issues identified in the Release 18 3GPP tethering study relate to the monitoring and reporting of tethering link and DN link latencies, and respectively, to the management of E2E QoS delay budget.

The latency monitoring and reporting solution presented herein is thus of relevance because in an E2E connection including a tethering link (e.g., Wi-Fi link, or a Bluetooth link), a 5G network and the Internet, the Wi-Fi segment and the Internet segment typically cannot guarantee latency. A low E2E latency is required by the XR applications to provide a good quality of experience (QoE) to the end user. Such a QoE may lead to the experience feeling more immersive to the user and also make the experience feel more interactive. To achieve the requisite low E2E latency of XR applications, one approach is to make the latency in the 5G network very conservative such that the end-to-end latency is below a target value. This, however, comes at a cost, because only a finite bandwidth is available in the wireless communication system and provisioning an unnecessarily low latency in the 5G network requires excessive radio resource allocation. Such excessive radio resource allocation might support a more robust modulation-and-coding scheme (MCS), but would require many other traffic flows to be deprived of bandwidth resources.

Accordingly, the solution presented here is to dynamically adjust the delay in the 5G network in accordance with the total delay incurred elsewhere on the E2E path. This requires a measure of the non 5G delay in the total E2E connection between the tethered headset and the application server. The delay on a Wi-Fi link may change over time depending on the interference generated by other nearby Wi-Fi networks operating within the same frequency band. Similarly, the delay between the UPF and the application server (AS) depends on the location of the selected UPF, the selected edge/AS and on the network congestion level. Therefore, measurements may be used to estimate these time-varying delays on the non-5G segments.

There is thus provided an efficient implementation the determination of delays across the non-5G segments of the E2E path between a glasses endpoint and an AS, or alternatively, an edge AS (EAS) for split-rendering.

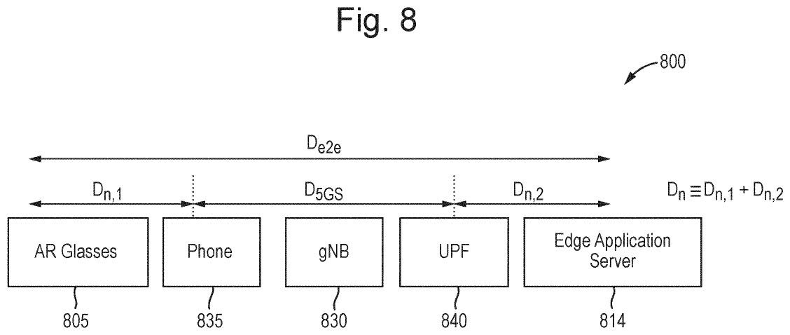

FIG. 8 illustrates an E2E path and subsequent path delays. In this example, the E2E path comprises AR glasses 805, a phone 835, a gNB 830, a UPF 840, and an Edge Application server 814. The delay notation illustrated in FIG. 8 is defined as follows.
Dₑ₂ₑ: denotes the E2E delay in one direction, i.e., either UL or DL.
D_{5G}: denotes the 5GS delay from the PSA UPF to the UE, which is measurable by means of core network QoS monitoring procedures described in TS 23.501 and RAN Layer 2 measuring procedures described in TS 38.314; this can be measured both based on average performance of DRBs and QoS flows, but also per QoS flow and per DRB per UE. For the latter, per QoS flow per UE QoS monitoring procedure is applied leveraging the GTP-U headers to carry the timestamps necessary for PSA UPF to NG-RAN measurements, whereas the delay between NG-RAN to UE is measured on average per DRB per UE conform RAN Layer 2 procedures at PDCP layer.
D_{n,1}: denotes the tether link (e.g., Wi-Fi, Bluetooth) delay.
D_{n,2}: denotes the DN link (e.g., connection between PSA UPF and AS, or alternatively, EAS) latency.
Dₙ: denotes the total non-5G/non-3GPP E2E delay accumulated over the tethered link and the DN link segments as Dₙ=D_{n,1}+D_{n,2}.

It is therefore useful to determine Dₙ so as to allow fine control of D_{5GS} by means of QoS rules such that the delay budget and requirements of an application, i.e., D_{e2e,max} is met, i.e., Dₑ₂ₑ=D_{5GS}+Dₙ≤D_{e2e,max}.

The delay measurement can thus be either performed on a segment-by-segment basis, whereby the delays detailed above are determined individually and because of interest is the determination of D_{n,1} and D_{n,2} delays.

For delay measurement, the measured delay may be representative of the delay to be experienced by data packets passing between the AR glasses 805 and the edge application server 814. Delay measurements based on out-of-band delay measurement messages such as the ping message (ICMP Echo and Echo Reply, according to RFC 792) may be easy to collect yet may not accurately reflect the delay experienced by the data packets. The latter is a consequence of two facts: i). the delay measurement ICMP message uses a protocol number (e.g., 1 for ping) that is different from the protocol number of an XR traffic data packet (e.g., 17 in case data packets are sent with RTP/UDP), and this results in different 5-tuples (src addr, dst addr, src port, dst port, protocol id), and consequently different QoS treatment in the 5GS communications links; ii). the packet size of a ICMP delay measurement typically is much smaller than that of a data packet (couple of tens of bytes), resulting in different transmission delays.

An alternative approach to delay measurement is represented by in-band delay measurements performed on top of the RTP/UDP stack, WebRTC stack, RTP/QUIC stack, WebRTC/QUIC stack or alike real-time communications protocols. This utilizes in some implementations RTP header extensions, e.g., WebRTC/RTP abs-send-time header extension (http://www.webrtc.org/experiments/rtp-hdrext/abs-send-time), and time synchronization relative to an NTP server to measure the delay at the receiver, or alternatively, at a network node along a network path, from the absolute sent time of an RTP packet, or alternatively, RTP packets enclosing an ADU. In another implementation, piggybacking on top of RTCP sender/receiver reports may be utilized together with RTP/RTCP multiplexing as per RFC 5761 for unicast sessions. In this case the RTP timestamps together with the RTCP sender/report inter-timestamps and receive times can be used to calculate an average round-trip time (RTT) and provide an estimate for the latter, for the UL, or alternatively, for the DL direction.

In case of in-band delay measurement the measurement framework requires an E2E measurement approach coupled with 5GS measurement procedure for the determination of Dₑ₂ₑ, D_{5G}S, and ultimately of the measurement of interest, i.e., Dₙ. This fact is due to the piggybacking strategy on top of RTP traffic originating from the application source.

3GPP has also defined in TS 23.288 v17.2.0 an architecture to support providing network analytics. In the architecture, the NWDAF provides analytics outputs to one or more Analytics Consumer NFs based on Data Collected from one or more Data Producer NFs. The Analytics Consumer NF may be one or more of an AF, OAM and 5G Core NFs (e.g., SMF, AMF, PCF).

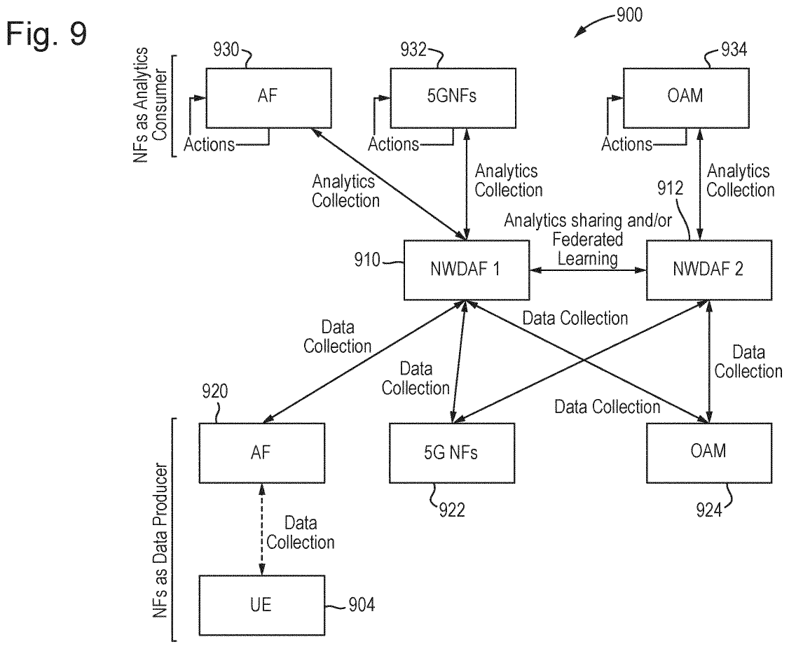

FIG. 9 illustrates an example wireless communication system 900. The system 900 comprises a UE 904 an NWDAF Analytics Logical Functions (ANLF) 910, an NWDAF Model Training Logical Function (MTLF) 912, a plurality of Data Producer Network Functions, in this example am Application Function (AF) 920, a 5G Network Function 922, and an Operations, Administration and Maintenance (OAM) 924. The wireless communication system 900 further comprises a plurality of Analytics Consumer Network Functions which in this example include an Application Function 930, a 5G Network Function 932, and an OAM 934. In the current 3GPP architecture, the NWDAFs 910, 912 (defined in 3GPP Technical Specification 23.288 v17.2.0) provide analytic output to one or more of the Analytics Consumer NFs 930, 932, and 934 based on data collected from one or more Data Producer NFs 920, 922 and 924. The analytic output may be derived by the NWDAFs 910, 912 using Analytics sharing and/or Federated Learning. The UE 904 may be embodied as a remote unit 102, a user equipment apparatus 200, or alternatively a tethered UE 1110 as described herein. The NWDAF 1 910 and NWDAF 2 912, may be embodied as a network unit 104, and a network node 300 as described herein.

A list of potential Analytics Consumer NF for each Analytics output the NWDAF provides is described in table 1 below.

TABLE 1
Example Analytics Consumer NFs

| NWDAF Analytics Output | Example Analytics Consumer NF |
|---|---|
| Slice Load Level | PCF, NSSF |
| Observed Service Experience | PCF, OAM |
| NF load analytics | All 5G core NFs, OAM |
| Network Performance Analytics | PCF, NEF, AF, or OAM |
| UE Mobility Analytics | AMF, SMF |
| UE Communication Analytics | AMF, SMF, PCF |
| Expected UE behavioural analytics | AMF, UDM, AF or OAM |
| Abnormal behaviour analytics | AMF, SMF, PCF |
| User Data Congestion analytics | NEF, AF |
| QoS Sustainability Analytics | AF |

To support XR services and applications, the following analytics are relevant to this disclosure. Such analytics can be beneficial for mobile XR users, or for the XR service providers who need to deploy the XR service in a target area and time (e.g., for an event) and requires the statistics/predictions on the QoS/network performance and availability.
QoS Sustainability Analytics: Provides information regarding the QoS change statistics for an Analytics target period in the past in a certain area or the likelihood of a QoS change for an Analytics target period in the future in a certain area.
Network Performance Analytics: Provides either statistics or predictions on the gNB status information, gNB resource usage, communication performance and mobility performance in an Area of Interest.
User Data Congestion Analytics: User Data Congestion related analytics can relate to congestion experienced while transferring user data over the control plane or user plane or both.
DN Performance Analytics: Provides statistics or predictions on the DN performance indicators for a specific edge computing application for a UE, group of UEs over a specific serving PSA UPF, DN application identifier or EAS.

In Release 17 the framework for UE data collection and reporting framework for event exposure (EVEX) has been completed. This provides the architecture and protocols for enabling the collection of UE and AS data and exposure of associated events to NF consumers through the generic architecture and procedures described by NWDAF.

To this end, the high-level procedures by which data is collected by a NWDAF from UE application(s) via an intermediary AF as data provider are exploited. This is achieved by a Data Collection AF (DCAF) which is registered with the NRF and connected as an event provider to the NWDAF. The DCAF relies on three possible Data Collection Clients:
a Direct Data Collection Client that operates directly on the UE endpoint and collects data relevant to the application operation and logic directly communicating with an instance of the DCAF;
an Indirect Data Collection Client that operates within an ASP backend with whom the UE application instance communicates collected data; the Indirect Data Collection Client collects the UE application data and relays it further to a DCAF instance; and/or
an AS/EAS which communicates with the DCAF as part of an ASP infrastructure, or via the NEF interfaces in distributed/separate domains deployments.

The DCAF and subsequently the Data Collection Clients may thus be provisioned by the Application Service Provider via a provisioning AF with a configuration meant to perform data collection directly from one UE or a group of UEs serving the application, or alternatively, from the AS/EAS serving application content to the one UE or the group of UEs. The configuration further comprises a Data Access Profile provisioned by the application provider. The Data Access Profile contains information about the data parameters to be collected (e.g., an Event ID), filtering metadata to apply to the collected data (e.g., location filters, time sampling restrictions, UE/application identifier filters etc.), and the reporting procedures. The Data Access profile may also define the processing to be performed by the DCAF of the collected data for generation and exposure of events to further NF, or alternatively, AF.

The DCAF is thus connected as a NF data producer, or alternatively event producer, with an NWDAF instance which is an event consumer. Further event consumers can be attached by means of the NWDAF service-based architecture. For instance, other event consumers may be other NFs, such as PCF, SMF, UPF or alike, or other AFs, like the application provider AF.

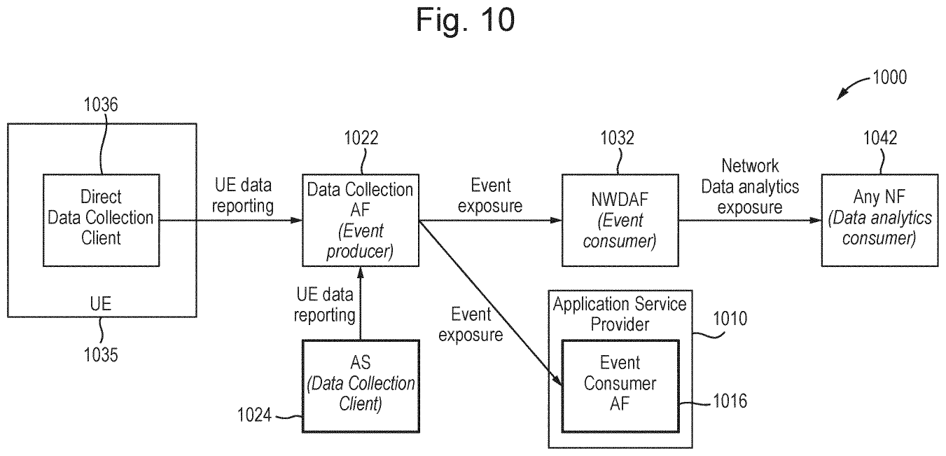

FIG. 10 illustrates a generic DCAF architecture depicted in simplified format. The NRF registration and provisioning AF connections of the DCAF are left out for brevity. A wireless communication device 1035 comprises a Direct Data Collection Client (DDCC) 1036 which reports to a Data Collection Application Function (DCAF) 1022. DCAF 1022 receives UE reporting data also from an Application Server 1024 and exposes an event to both an NWDAF 1032 and an Event consumer application function 1016 in an ASP 1010. NWDAF 1032 exposes network data analytics to any network function 1042 that wishes to consume data analytics. As such, the DCAF 1022 collects data over a configured data collection session (i.e., by means of a Data Access Profile acquiring data over a RESTful APIs served over HTTPS authenticated connections) with the Direct Data Collection Client 1036 and the AS 1024, which may be an Edge AS. The collected data is processed at the DCAF 1022 to generate and expose an event which is further consumed by the NWDAF 1032 for analytics. The NWDAF 1032 in turn performs analytics on the collected events and outputs the results to other NF/AF consumers 1042.

The Data Access Profile is defined in TS 26.531 v17.0.0 “Data Collection and Reporting; General Description and Architecture”. Various restrictions along the time, user, and location dimensions, are available.
Restrictions along time: determine granularity of access to UE data along the time axis. The finest granularity allows access to events as they take place in time (no restriction). The coarsest level of access aggregates all event data along the time axis to produce a single aggregated value given an aggregation window.
Restrictions along users: allow the provisioning AF to restrict access to UE data related events based on groups. The finest granularity allows the event consumer to access events related to single users, or alternatively, UEs. Coarse granularity access exposes aggregated collected event data based on user groups, as defined by an application (e.g., UEs that run a certain application version). The coarsest granularity access exposes the data being aggregated for all users.
Restrictions along location: allow the Provisioning AF to restrict access to UE data related events based on geographical location of the data collection client during the event. The finest granularity allows the event consumer to access events individually, irrespective of the location. Coarse granularity access exposes aggregated collected event data based on a geographical area. The coarsest level of access aggregates all event data along locations to produce a single aggregated value for all locations.

The baseline set of aggregation filters for the DCAF is defined currently in 3GPP TS 26.532 v17.1.0 “Data Collection and Reporting. Protocols and Formats”, in particular at Table 4.5.2-1. The baseline DCAF aggregation filters based on reporting period is thus as follows:
None: no aggregation applied, all reported data records are exposed as individual events.
Count: number of reported data records is exposed to event consumers
Mean: mean average of the values in reported data records is exposed to event consumers.
Maximum: maximal observed value in reported data records is exposed to event consumers.
Minimum: minimal observed value in reported data records is exposed to event consumers.
Sum: sum of the values in reported data records is exposed to event consumers.

There is presented herein a solution related to the data collection, reporting, analytics, and usage of said outputs for the 5GS, or alike, QoS rules adaptation regarding latency, or alternatively, delay budget control of latency-sensitive immersive, interactive and/or critical applications over tethered links UEs, or alike. The solution comprises data collection in support of determination of non-3GPP based link segments based on UE and AS delay/latency metrics determination and reporting. It should be noted that while the following examples are presented in the context of XR applications, the general methods and apparatuses are broadly applicable by one trained in the art to any latency sensitive applications. For example, the arrangements described herein might be applied to remote operation control of a machine or other apparatus.

A tethered UE serving an XR application may be formed of a combination of XR glasses tethered to a 5G device for Internet connectivity, or alternatively, DN connectivity towards the AS/EAS of an ASP. In such an embodiment, the 5G device, irrespective of the tethering architecture, i.e., tethered standalone XR glasses, or alternatively, tethered display XR glasses, the 5G device, e.g., a mobile phone, a mobile tablet, an XR access point or gateway, provides a basic functionality and implementation of a Media Session Handler (MSH). The MSH operates on the 5G device end as a generic function on which to setup 5GS capabilities and support 5GS integration. Such functionality may comprise at least one of: QoS support, metrics collection and reporting, and setup of edge functionalities for the XR application.

The MSH of the tethered UE may be collocated with the MAF such that both reside on the 5G device, e.g., the mobile UE. One example in this sense is an implementation of a tethered XR display UE, wherein the MAF and embedded MSH are at least in part present on the 5G device, as the 5G device performs media processing, i.e., encoding/decoding, synchronization of media sources, media content distribution, spatial scene description and associated metadata processing, etc. In this example, the 5G device processing power is thus utilized to access the raw media formats via the MAF, process the scene management and access the XR runtime API for rendering on the tethered XR glasses, which are an implementation of the tethered display XR category. Further, the 5G device may be additionally supported in the processing of media by split rendering over an EAS, or equivalently, an AS, whereby spatial processing and pre-rendering is performed according to available pose information for a scene, as exemplified in FIG. 7.

The MSH of the tethered UE may be at least partially present on the 5G device. In such an arrangement the lightweight MSH on the 5G device provides at least a basic functionality of exposing the 5GS connectivity capabilities, integrating 5GS elements, which in part support at least one of QoS support, metrics collection and reporting, and setup of edge functionalities. The lightweight MSH on the 5G device can have a corresponding and associated MSH deployed as part of the MAF hosted on the tethered XR glasses, whereby the two MSH instances communicate to one another via the tether link at least for the purpose of one of QoS support, metrics collection and reporting, and setup of edge functionalities. One example is illustrated graphically in FIG. 5, whereby tethered standalone XR glasses are used to access and process the media flows and associated streams based on the glasses MAF, and whereby the 5G device provides 5GS connectivity and basic session control functionality by means of a lightweight MSH instance. The latter can interact in an implementation via APIs with both the XR application, whereby the XR application can perform configuration regarding QoS support, metrics data collection and reporting, edge application support, and with the peer MSH on the XR glasses for integration of 5GS capabilities.

Furthermore, the 5G device may simply act as an IP layer relay to the 5GS for the tethered XR glasses. The tethered XR glasses are thus standalone and aware of the 5GS, as their implementation provides a complete MAF functionality and MSH. On the other hand, there is no partial MSH instance running on the 5G device and the tethered XR glasses are operating standalone to setup 5G System capabilities and support 5GS integration. As such the MAF in the XR tethered glasses manages singlehandedly the setup of edge functionalities, provides QoS support, data collection, and reporting functionalities available based on the 5GS connectivity provided via the IP relay 5G device.

The tethered UE may be capable of measuring D_{n,1} based on a segment-by-segment measurement procedure, whereby the ICMP Echo-Reply, or alternatively, ICMP Timestamp, procedure as per RFC 792 is used to determine out-of-band the delay of the tethering link up to Layer 3. In one implementation the MSH on the 5G device side is responsible to triggering the measurement procedure and recording the RTT measurements of D_{n,1} segment representing the delay estimate of twice UL/DL delay incurred due to the tethering link between the XR glasses and the 5G device.

In one implementation these measurements are performed upon a PDU session establishment or modification, whereby the QoS rules are updated.

In another implementation these measurements are grouped and performed periodically, e.g., with a frequency of 1 second, for a maximum time duration, e.g., 60 seconds, to limit the overhead of monitoring the tethering link. However, in another implementation, these measurements may be started and stopped based on application configured control events (e.g., QoE degradation due to certain application buffer threshold exceedance etc.) or timers (e.g., a 60 second timer to conduct measurements each second when determined by the application). The time and sample acquisition limits can be configured in various implementations to reduce the monitoring overhead on the XR glasses, the 5G device and the MSH instance.

In yet another implementation multiple measurements are aggregated to determine an average delay duration. In such scenarios the aggregation filter may be applied by the MSH per number of accumulated sample measurements or per aggregation window duration.
In one example of aggregation per number of accumulated sample measurements, each 30 measurements are averaged and their average RTT delay, or alternatively, RTT/2 delay is determined.
In another example of aggregation per window duration, the samples accumulated over a span of 60 seconds are aggregated together and their average RTT delay, or alternatively, RTT/2 delay is determined.
In a third example, a combination of the two aggregation methods is performed to determine an average RTT delay, or alternatively, RTT/2 delay with a granularity based on both the number of samples and/or acquisition window.

The tethered UE may be capable of measuring Dₑ₂ₑ based on an E2E (i.e., between UE and AS/EAS) measurement procedure.

This procedure may be based on out-of-band measurements based at least in part on the ICMP Echo-Reply, or alternatively, ICMP Timestamp, procedure as per RFC 792 which can determine the E2E RTT, and thus the Dₑ₂ₑ delay parameter.

Alternatively, this procedure may be based on in-band piggybacking on RTP or RTCP packets, whereby the timestamping required for E2E measurements is in part based on the RTP timestamp, RTP header extension abs-send-time, or RTCP timestamp and RTCP receive timestamp. These procedures allow in effect the determination of Dₑ₂ₑ based on the RTP/RTCP timestamp piggybacking similarly to the ICMP Echo Reply, or alternatively, ICMP Timestamp procedures as detailed in RFC 792. However, this would benefit in-band processing and less utilization of communication, processing, and bandwidth resources, providing a more accurate Dₑ₂ₑ estimation. Furthermore, by piggybacking on the RTP and/or RTCP, the same QoS flow through the CN is utilized as the actual application traffic. On the other hand, in case of ICMP delay E2E monitoring, this is not the case as the protocol is being mapped to a different QoS flow, with different delay budget and error rate parameters. In some implementations, the latter is in fact a worse QoS flow setup than the one of the applications, and hence the ICMP-based measurements represent an upper bound on the E2E delay. As such, the choice between ICMP-based measurements and RTP-based measurements is question of implementation detail, requiring a trade-off between portability, or alternatively, generality, and performance.

Similar measurements as for the UE can be performed on the AS side over the user plane path. The measurements may be performed by the AS relative to the PSA UPF on the basis of out-of-band ICMP Echo Reply/ICMP Timestamp procedure. This determines the RTT between the AS, or alternatively, EAS and the PSA UPF which can in turn provide an estimate of the D_{n,2} network segment for the delay incurred due to the DN link segment. Alternatively, the measurement may be carried by the UPF, in which case the metrics and data collected are already present within the 5GS CN.

The AS, or alternatively, EAS, may perform E2E (i.e., between UE and AS/EAS) delay measurements and data collection. Similar delay measurements may be performed on the UE side, as explained above, this is based either on the ICMP available procedures (e.g., Echo Reply, and Timestamp as per RFC 792), or based on piggybacking on top of RTP/RTCP traffic.

To determine the total non-3GPP link segments delay, Dₙ=D_{n,1}+D_{n,2}, the collected delay parameters may be centralized regardless of whether the measurements are performed by segment-by-segment, E2E, in-band or out-of-band procedures.

Such centralization may be performed based on the data collection and reporting framework available in TS 26.531 v17.0.0 and 5GS, whereby both the UE and AS/EAS are enabled to perform data collection and report them to a DCAF. The DCAF, which is already registered with the NRF for a set of Event IDs based on Nnrf_NFManagement_NFRegister{EventiDs}, is provisioned by an ASP over a provisioning AF to create a session for data collection related to delay experienced over non-3GPP link segments. The DCAF is thus set up by Ndcaf_DataReportingProvisioning_CreateSession and Ndcaf_DataReportingProdsioning_CreateConfiguration procedures to create a session and configuration for the DCAF registered Event IDs given a Data Access Profile indicating which data parameters are to be collected, reported and how they are to be processed by the DCAF. This operation may thus configure the experienced delay on at least one of three possible network segments to yield the following events identifiers:
E2eDelayExperience: this is the event ID characterizing the collected and processed data events on the experienced E2E (i.e., UE to AS/EAS) delay based on E2E measurements available, i.e., carried over either by the UE device, and/or the AS device.
TetheredLinkDelayExperience: this is the event ID determining the collected and processed data events on the experienced tethered link (i.e., XR glasses, or alike tethered/indirectly connected devices to 5GS, to 5G device) delay based on segment-by-segment measurements carried over by the MSH on the 5G device.
DnDelayExperience: this is the event ID determining the collected and processed data events on the experienced DN link (i.e., AS/EAS to UPF link) delay based on segment-by-segment measurements carried over by the EAS/AS.

Once the DCAF instance is provisioned by the ASP for an application, e.g., XR application, the NWDAF subscribes to an event exposure whereby the DCAF acts as the event producer and the NWDAF is an event consumer and producer of analytics output of said DCAF events.

After this step, the Data Collection Clients can then create their sessions, e.g., by Ndcaf_DataReportingCreateSession, for reporting and perform data collection and reporting based on the configuration of the DCAF. The latter indicates to the clients the data to be collected and reported in association with the EventID of the DCAF under which the current session has been configured. Given this information, the Data Collection Clients perform reports to the DCAF via the Ndcaf_DataReporting_Report procedure.

A tethered UE based Direct Data Collection Client may be embedded and instantiated by the MSH residing in the 5G device, whereby the MSH can collect (depending on the configured measurement procedure by the DCAF) the data necessary for delay parameters estimates of D₁ (the tethered XR glass to UE link) or of Dₑ₂ₑ.

An EAS/AS may act as a Data Collection Client by firstly initiate a data collection by accessing the APIs of the Ndcaf_DataReporting_*Session for data reporting session management, and secondly by reporting collected data via the APIs of the Ndcaf_DataReporting_Report procedure. Depending on the ASP deployment and trusted vs. non-trusted domain configuration, the interaction with the procedures is performed either directly based on communication with the DCAF, or alternatively, indirectly based on communication with the NEF exposing the DCAF functionality. As such, in some embodiments, the AS/EAS can collect and report data for delay parameters estimates of D_{n,2} (the link between the PSA UPF and the AS/EAS) or, alternatively, of Dₑ₂ₑ.

The DCAF Data Access Profile configured aggregation filter will process further the collected data events and expose the output events by means of the 5GS service-based architecture to other subscribed NFs and AFs event consumers.

A consumer may be represented by an AF of the ASP which uses the DCAF events to trigger some actions on the application logic plane.

Alternatively, a consumer may be represented by another NF, e.g., NWDAF, PCF, UPF or alike whereby the events are used to generate analytics, configure, or update CN and 5GS behavior.

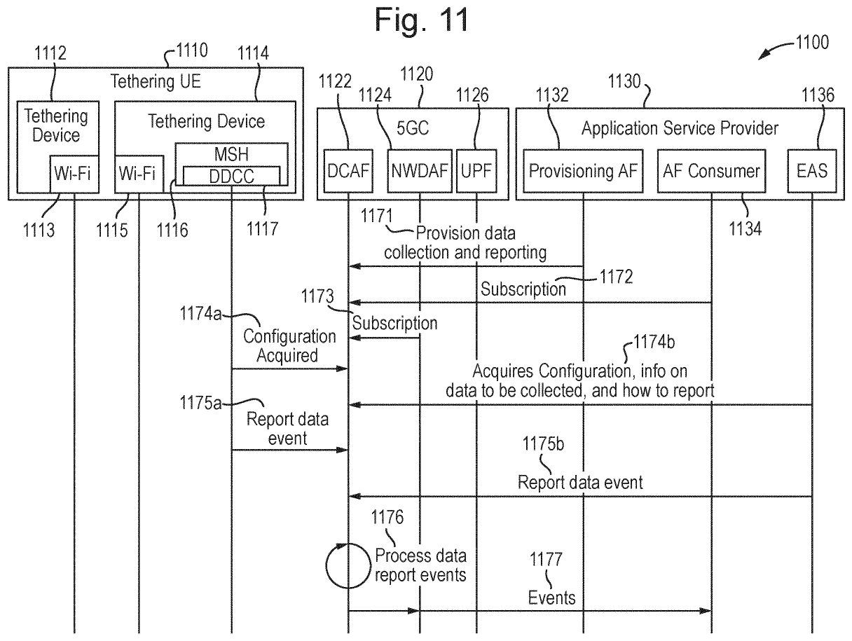

FIG. 11 illustrates a method 1100 of a tethered application DCAF for the data collection and reporting of non-3GPP link delays. The system illustrated in FIG. 11 comprises a Tethered UE 1110, a 5G Core (5GC) 1120, and an Application Service Provider (ASP) 1130. The tethered UE 1110 comprises a tethering device 1114 such as a smart phone, and a tethered device 1112 such as a VR headset, or alternatively AR glasses. The tethered device 1112 and the tethering device 1114 are tethered by a Wi-Fi link via respective Wi-Fi modules 1113, 1115. Tethering device 1114 further comprises a Media Session Handler (MSH) 1116 which includes a direct data collection client (DDCC) 1117.

The 5GC 1120 comprises a Data Collection AF (DCAF) 1122, a Network Data Analytics Function (NWDAF) 1124 and a User Plane Function (UPF) 1126. The Application Service Provider 1130 comprises a Provisioning Application Function 1132, an Application Function Consumer 1134 and an Edge Application Server (EAS) 1136.

The method 1100 commences at 1171, where the ASP 1130 provisions the DCAF 1122 for the UE and AS data collection and reporting for two events, i.e., TetheredLinkDelayExperience and DnDelayExperaence. These events are to be exposed by the DCAF 1122 with a user granularity and a coarse location granularity for an aggregation window of 30 seconds given a data collection frequency of 2 seconds by means of out-of-band ICMP Echo Replay procedure. The aggregation filter to be applied by the DCAF over the aggregation windows is the maximum aggregation event filter.
The provisioning AF 1132 performs Ndcaf_DataReportingProvisioning_CreateSession to create sessions for the exposure of the desired Event IDs
The provisioning AF 1132 also configures via the Ndcaf_DataReportingProvisioning_CreateConfiguration the desired Data Access Profile according to the data to be collected, collection and reporting configurations, including also the DCAF aggregation of events to output the maximum delay event for each Event ID every 30 s.

At 1172, the ASP event consumer, in this case the AF Consumer 1134, subscribes to the two Event IDs (TetheredLinkDelayExperaence and DnDelayExperaence) by means of Naf_EventE xposure_Subscrbe.

At 1173, the NWDAF 1124 subscribes to the two Event IDs (TetheredLinkDelayExperaence and DnDelayExperaence) by means of Naf_EventExposure_Subscribe.

At 1174a, the Direct Data Collection Client 1117 instantiated by the MSH 1116 at the tethered UE 1110 acquires the configuration from DCAF 1122 to create a reporting session for the TetheredLinkDelayExperaence by means of Ndcaf_DataReporting_CreateSession and obtains information on the data to be collected and instructions on how to perform the reporting.

At 1174b, the ASP AS/EAS 1136 also acquires the configuration from DCAF 1122 to create a reporting session for the TetheredLinkDelayExperaence by means of Ndcaf_DataReporting_CreateSession and obtains information on the data to be collected and instructions on how to perform the reporting.

At 1175a, the Direct Data Collection Client 1117 reports data events to DCAF 1122 with Ndcaf_DataReporting_Report{TetheredLinkDelayExperience}indicating events containers comprising the D_{n,1} delay parameter.

At 1175b, the AS/EAS 1136 of the ASP 1130 also reports data events to DCAF 1122 with Ndcaf_DataReporting_Report{DnDelayExperience}indicating events containers comprising the D_{n,2} delay parameter.

At 1176, the DCAF 1122 processes the ingress data report events according to the data processing rules in the configured Data Access Profile of each corresponding session and exposes further to its event consumers the maximum delay of D_{n,1} and D_{n,2} each 30 seconds. The latter exposure of the events is done per Event ID with the configured Data Access Profile granularity based on Naf_EventExposure_Notify{TetheredLinkDelayEperience,DnDelayExperience}.

At 1177, consumers receive asynchronously the events and can start processing them further based on their needs.

It should be noted that the provisioning for the data collection and reporting to the DCAF by either the tethered UE or AS/EAS procedures may be conditioned by an ASP provisioning AF on reporting the experienced and recorded delay values only when they exceed an ASP/application determined delay threshold. In such arrangements the threshold is determined by the ASP given the application requirements on the E2E delay budget, or alternatively, on the segment-by-segment delay budget.
In one example, the ASP may require the E2E delay budget to not exceed 50 ms, i.e., D_{e2e,max}=50 ms, and as such any of the tethered UE (i.e., the MSH/Direct Data Collection Client) and AS/EAS Data Collection Clients, shall report the measured E2E delay, Dₑ₂ₑ, to the DCAF if Dₑ₂ₑ>Dₑ₂ₑ,max, or alternatively, if Dₑ₂ₑ>D_{e2e,max}.
In another example, the ASP may require the tethered UE tethering link to not exceed 10 ms, i.e., D_{n,1,max}=10 ms, and as such the tethered UE Data Collection Client (i.e., the MAF, or alternatively, MSH Direct Data Collection Client Instance) shall report the measured tethered link delay, D_{n,1}, to the DCAF if D_{n,1}≥D_{n,1,max}, or alternatively if D_{n,1}>D_{n,1,max}.
In a third example, the ASP may require the DN link (from PSA UPF/UPF to the AS/EAS) to not exceed 10 ms, i.e., D_{n,2,max}=10 ms, and as such the AS/EAS Data Collection shall report the measured DN link delay, D_{n,2}, to the DCAF if D_{n,2}>D_{n,2,max}, or alternatively, if D_{n,2}>D_{n,2,max}.

Where conditional threshold-based reporting, or alternatively, event-based reporting is performed by the Data Collection Clients and/or by the EAS/AS, the DCAF may apply additional aggregation filtering to count the occurrence of threshold-based, or alternatively, event-based delay reports over a provisioned aggregation window time duration, as provisioned and configured by the provisioning AF of the ASP. On the other hand, where interval-based reporting is performed by the Data Collection Clients and/or by EAS/AS, the DCAF may apply additional aggregation filtering to average, or alternatively, to determine the maximum of the delay reports over the provisioned aggregation window time duration.

The provisioning for the data collection and reporting to the DCAF by either the tethered UE or AS/EAS procedures may be conditioned by an ASP provisioning AF on reporting the experienced and recorded delay values only when an event is detected either by means of the application logic or by other implementation-specific means. In such arrangements, the delay measurements are collected by the Data Collection Clients only when the provisioned event is triggered. In an example, the provisioned event may be determination of a tethered connection by the application logic upon initiation of a media session over the tethering link.

Accordingly, there is provided a data collection application function for exposure of link delay performance events for an application experienced via a tethered connection between a first device and a second device. The data collection application function comprises a processor; and a memory coupled with the processor. The processor is configured to cause the data collection application function to: receive a configuration for a data access profile for data collection, the data concerning a link delay in the tethered connection; apply the data access profile to at least one data collection client; receive collected link delay measurements from the at least one data collection client; process the link delay measurements based in part on the data access profile to produce one or more link delay performance events; and expose the one or more link delay performance events corresponding to the application experienced via the tethered connection.

The data collection application function may thus expose link delay performance events that facilitate the collection of measurements related to the performance of a tethered connection. Such measurements are required to provide performance analytics to properly understand the end-to-end quality of service. One measure of the end-to-end quality of service may comprise an end-to-end latency.

The data collection application function may comprise a Data Collection Application Function (DCAF). The DCAF may expose the one or more link delay performance events to a first network node. The first network node may comprise a network analytics function. The first network node may be an NWDAF.

The configuration for a data access profile for data collection may include an indication to provide analytics in respect of a link delay. The tethered connection for the application may comprise a tethered link delay or DN link delay. The performance analytics for the tethered link connection may comprise a delay or DN link delay. The performance analytics of a delay may comprise either an average delay or a maximum delay.

The application experienced via a tethered connection between a first device and a second device may be conducted by way of an application session. The application session may include communication between a wireless communication device and an application server. The application session may comprise a plurality of links which are communicated by a plurality of access technologies.

The first device may be a tethering device, and the second device may be a tethered device. The first device may be a wireless communication device. By way of example, the second device may comprise a virtual reality headset connected to the wireless communication device via Bluetooth or Wi-Fi.

The first device may be a tethered device and the second device may be a tethering device. The second device may be a wireless communication device. By way of example, the first device may comprise a virtual reality headset connected to the wireless communication device via Bluetooth or Wi-Fi.

The first device and the second device may be arranged to provide connectivity access to a data network hosting at least one of an application server and an edge application server corresponding to the application.

The at least one data collection client may comprise at least one of: a direct data collection client as a logical component of at least one of the first device and the second device; a data collection client as a logical component at an application server corresponding to the application; and/or a data collection client at a logical component at an edge application server corresponding to the application.

The link delay measurements may be obtained by at least one of: in-band, out-of-band, end-to-end, and segment-by-segment delay measuring procedures. The delay measuring procedures may be performed relative to the application traffic.

The link delay measurements may be obtained by a measuring procedure comprising at least one of: an Internet Control Message Protocol (ICMP) Echo Reply procedure; an ICMP Timestamp Request and ICMP Timestamp Response procedure; an RTCP Sender and Receiver Report with delay of last sender report marking procedure; and an RTP PDU timestamps piggybacking procedure by means of at least one of RTP header extensions and RTP payload.

The data collection client may comprise a media session handler (MSH).

The link delay measurements may be based on at least one of: an interval-based collection, whereby a measurement is collected with a configured sampling frequency; a threshold-based collection, whereby a measurement is collected if the measurement exceeds a configured threshold value; and/or an event-based collection, whereby a measurement is collected if a configured event is triggered. By way of example, an interval-based data collection may use a sampling frequency of link delay measurements of 500 milliseconds. Byway of further example, a threshold-based data collection may use a link delay threshold of 20 milliseconds for which any link delay rising over the threshold generates a collection of link delay measurement data. In another example, an event-based data collection may use a tethered session establishment or update event such that when triggered by the event link delay measurement data is collected.

A link delay performance event may comprise an indication of at least one of: a link delay performance of a tethered connection; a link delay performance of an end-to-end link, wherein; and/or a link delay performance of a data network link. The end-to-end link may comprise the link between one of the first device and the second device and one of an application server and an edge application server. The data network link may comprise the link between a PDU session anchor user plane function (PSA UPF) and one of the application server and the edge application server.

The indication may include an aggregation filter applied over a configured aggregation window wherein the aggregation filter is based on at least one of: an average operation of the collected link delay performance measurements collected over the duration of the aggregation window; a maximum operation of the collected link delay performance measurements collected over the duration of the aggregation window; and/or a counting operation of the collected link delay performance measurements collected over the duration of the aggregation window.

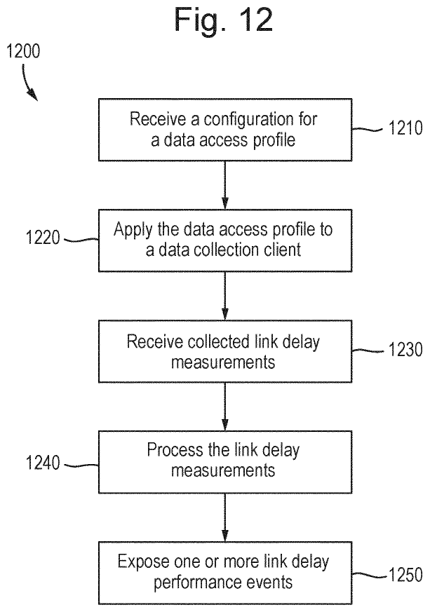

FIG. 12 illustrates a method 1200 performed by a data collection application function, the method 1200 for exposure of link delay performance events for an application experienced via a tethered connection between a first device and a second device, the method 1200 comprising; receiving 1210 a configuration for a data access profile for data collection, the data concerning a link delay in the tethered connection; and applying 1220 the data access profile to at least one data collection client. The method 1200 further comprises: receiving 1230 collected link delay measurements from the at least one data collection client; processing 1240 the link delay measurements based in part on the data access profile to produce one or more link delay performance events; and exposing 1250 the one or more link delay performance events corresponding to the application experienced via the tethered connection.

In certain embodiments, the method 1200 may be performed by a processor executing program code, for example, a microcontroller, a microprocessor, a CPU, a GPU, an auxiliary processing unit, a FPGA, or the like.

The data collection application function may thus expose link delay performance events that facilitate the collection of measurements related to the performance of a tethered connection. Such measurements are required to provide performance analytics to properly understand the end-to-end quality of service. One measure of the end-to-end quality of service may comprise an end-to-end latency.

The data collection application function may comprise a Data Collection Application Function (DCAF). The DCAF may expose the one or more link delay performance events to a first network node. The first network node may comprise a network analytics function. The first network node may be an NWDAF.

The configuration for a data access profile for data collection may include an indication to provide analytics in respect of a link delay. The tethered connection for the application may comprise a tethered link delay or DN link delay. The performance analytics for the tethered link connection may comprise a delay or DN link delay. The performance analytics of a delay may comprise either an average delay or a maximum delay.

The application experienced via a tethered connection between a first device and a second device may be conducted by way of an application session. The application session may include communication between a wireless communication device and an application server. The application session may comprise a plurality of links which are communicated by a plurality of access technologies.

The first device may be a tethering device, and the second device may be a tethered device. The first device may be a wireless communication device. By way of example, the second device may comprise a virtual reality headset connected to the wireless communication device via Bluetooth or Wi-Fi.

The first device may be a tethered device and the second device may be a tethering device. The second device may be a wireless communication device. By way of example, the first device may comprise a virtual reality headset connected to the wireless communication device via Bluetooth or Wi-Fi.

The first device and the second device may be arranged to provide connectivity access to a data network hosting at least one of an application server and an edge application server corresponding to the application.

The at least one data collection client may comprise at least one of: a direct data collection client as a logical component of at least one of the first device and the second device; a data collection client as a logical component at an application server corresponding to the application; and/or a data collection client at a logical component at an edge application server corresponding to the application.

The link delay measurements may be obtained by at least one of: in-band, out-of-band, end-to-end, and segment-by-segment delay measuring procedures. The delay measuring procedures may be performed relative to the application traffic.

The link delay measurements may be obtained by a measuring procedure comprising at least one of: an Internet Control Message Protocol (ICMP) Echo Reply procedure; an ICMP Timestamp Request and ICMP Timestamp Response procedure; an RTCP Sender and Receiver Report with delay of last sender report marking procedure; and an RTP PDU timestamps piggybacking procedure by means of at least one of RTP header extensions and RTP payload.

The data collection client may comprise a media session handler (MSH).

The link delay measurements may be based on at least one of: an interval-based collection, whereby a measurement is collected with a configured sampling frequency; a threshold-based collection, whereby a measurement is collected if the measurement exceeds a configured threshold value; and/or an event-based collection, whereby a measurement is collected if a configured event is triggered. By way of example, an interval-based data collection may use a sampling frequency of link delay measurements of 500 milliseconds. Byway of further example, a threshold-based data collection may use a link delay threshold of 20 milliseconds for which any link delay rising over the threshold generates a collection of link delay measurement data. In another example, an event-based data collection may use a tethered session establishment or update event such that when triggered by the event link delay measurement data is collected.

A link delay performance event may comprise an indication of at least one of: a link delay performance of a tethered connection; a link delay performance of an end-to-end link, wherein; and/or a link delay performance of a data network link. The end-to-end link may comprise the link between one of the first device and the second device and one of an application server and an edge application server. The data network link may comprise the link between a PDU session anchor user plane function (PSA UPF) and one of the application server and the edge application server.

The indication may include an aggregation filter applied over a configured aggregation window wherein the aggregation filter is based on at least one of: an average operation of the collected link delay performance measurements collected over the duration of the aggregation window; a maximum operation of the collected link delay performance measurements collected over the duration of the aggregation window; and/or a counting operation of the collected link delay performance measurements collected over the duration of the aggregation window.

There is further provided a data collection client for exposure of link delay performance events for an application experienced via a tethered connection between a first device and a second device. The data collection client comprises a processor; and a memory coupled with the processor. The processor is configured to cause the apparatus to: receive a data access profile from a data collection application function; collect link delay measurements in accordance with the received data access profile; and send collected link delay measurements to the data collection application function.

The data collection application function may thus expose link delay performance events that facilitate the collection of measurements related to the performance of a tethered connection. Such measurements are required to provide performance analytics to properly understand the end-to-end quality of service. One measure of the end-to-end quality of service may comprise an end-to-end latency.

The data collection application function may comprise a Data Collection Application Function (DCAF). The DCAF may expose the one or more link delay performance events to a first network node. The first network node may comprise a network analytics function. The first network node may be an NWDAF.

The configuration for a data access profile for data collection may include an indication to provide analytics in respect of a link delay. The tethered connection for the application may comprise a tethered link delay or DN link delay. The performance analytics for the tethered link connection may comprise a delay or DN link delay. The performance analytics of a delay may comprise either an average delay or a maximum delay.

The application experienced via a tethered connection between a first device and a second device may be conducted by way of an application session. The application session may include communication between a wireless communication device and an application server. The application session may comprise a plurality of links which are communicated by a plurality of access technologies.

The first device may be a tethering device and the second device may be a tethered device. The first device may be a wireless communication device. By way of example, the second device may comprise a virtual reality headset connected to the wireless communication device via Bluetooth or Wi-Fi.

The first device may be a tethered device and the second device may be a tethering device. The second device may be a wireless communication device. By way of example, the first device may comprise a virtual reality headset connected to the wireless communication device via Bluetooth or Wi-Fi.

The data collection client may be comprised within at least one of: the first device; the second device, and/or; an application service provider device. The application service provider device may comprise an application server, or an edge application server.

The first device and the second device may be arranged to provide connectivity access to a data network hosting at least one of an application server and an edge application server corresponding to the application.

The data collection client may comprise at least one of: a direct data collection client as a logical component of at least one of the first device and the second device; a data collection client as a logical component at an application server corresponding to the application; and/or a data collection client at a logical component at an edge application server corresponding to the application.

The link delay measurements may be obtained by at least one of: in-band, out-of-band, end-to-end, and segment-by-segment delay measuring procedures. The delay measuring procedures may be performed relative to the application traffic.

The link delay measurements may be obtained by a measuring procedure comprising at least one of: an Internet Control Message Protocol (ICMP) Echo Reply procedure; an ICMP Timestamp Request and ICMP Timestamp Response procedure; an RTCP Sender and Receiver Report with delay of last sender report marking procedure; and/or an RTP PDU timestamps piggybacking procedure by means of at least one of RTP header extensions and RTP payload.

The data collection client may comprise a media session handler (MSH).

The link delay measurements may be based on at least one of: an interval-based collection, whereby a measurement is collected with a configured sampling frequency; a threshold-based collection, whereby a measurement is collected if the measurement exceeds a configured threshold value; and/or an event-based collection, whereby a measurement is collected if a configured event is triggered. By way of example, an interval-based data collection may use a sampling frequency of link delay measurements of 500 milliseconds. Byway of further example, a threshold-based data collection may use a link delay threshold of 20 milliseconds for which any link delay rising over the threshold generates a collection of link delay measurement data. In another example, an event-based data collection may use a tethered session establishment or update event such that when triggered by the event link delay measurement data is collected.

The method link delay performance event may comprise an indication of at least one of: a link delay performance of a tethered connection; a link delay performance of an end-to-end link; and a link delay performance of a data network link. The end-to-end link is the link between one of the first device and the second device and one of an application server and an edge application server. The data network link is the link between a PDU session anchor user plane function (PSA UPF) and one of the application servers and the edge application server.

The indication may include an aggregation filter applied over a configured aggregation window wherein the aggregation filter is based on at least one of: an average operation of the collected link delay performance measurements collected over the duration of the aggregation window; a maximum operation of the collected link delay performance measurements collected over the duration of the aggregation window; and/or a counting operation of the collected link delay performance measurements collected over the duration of the aggregation window.

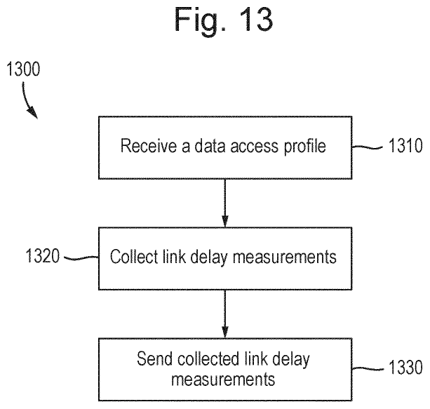

FIG. 13 illustrates a method 1300 performed by a data collection client, the method 1300 for exposure of link delay performance events for an application experienced via a tethered connection between a first device and a second device. The method 1300 comprises: receiving 1310 a data access profile from a data collection application function; collecting 1320 link delay measurements in accordance with the received data access profile; and sending 1330 collected link delay measurements to the data collection application function.

In certain embodiments, the method 1300 may be performed by a processor executing program code, for example, a microcontroller, a microprocessor, a CPU, a GPU, an auxiliary processing unit, a FPGA, or the like.

The data collection application function may thus expose link delay performance events that facilitate the collection of measurements related to the performance of a tethered connection. Such measurements are required to provide performance analytics to properly understand the end-to-end quality of service. One measure of the end-to-end quality of service may comprise an end-to-end latency.

The data collection application function may comprise a Data Collection Application Function (DCAF). The DCAF may expose the one or more link delay performance events to a first network node. The first network node may comprise a network analytics function. The first network node may be an NWDAF.

The configuration for a data access profile for data collection may include an indication to provide analytics in respect of a link delay. The tethered connection for the application may comprise a tethered link delay or DN link delay. The performance analytics for the tethered link connection may comprise a delay or DN link delay. The performance analytics of a delay may comprise either an average delay or a maximum delay.

The application experienced via a tethered connection between a first device and a second device may be conducted by way of an application session. The application session may include communication between a wireless communication device and an application server. The application session may comprise a plurality of links which are communicated by a plurality of access technologies.

The first device may be a tethering device and the second device may be a tethered device. The first device may be a wireless communication device. By way of example, the second device may comprise a virtual reality headset connected to the wireless communication device via Bluetooth or Wi-Fi.

The method first device may be a tethered device and the second device may be a tethering device. The second device may be a wireless communication device. By way of example, the first device may comprise a virtual reality headset connected to the wireless communication device via Bluetooth or Wi-Fi.

The data collection client may be comprised within at least one of: the first device; the second device, and/or; an application service provider device. The application service provider device may comprise an application server, or an edge application server.

The first device and the second device may be arranged to provide connectivity access to a data network hosting at least one of an application server and an edge application server corresponding to the application.

The data collection client may comprise at least one of: a direct data collection client as a logical component of at least one of the first device and the second device; a data collection client as a logical component at an application server corresponding to the application; and/or a data collection client at a logical component at an edge application server corresponding to the application.

The link delay measurements may be obtained by at least one of: in-band, out-of-band, end-to-end, and segment-by-segment delay measuring procedures. The delay measuring procedures may be performed relative to the application traffic.

The link delay measurements may be obtained by a measuring procedure comprising at least one of: an Internet Control Message Protocol (ICMP) Echo Reply procedure; an ICMP Timestamp Request and ICMP Timestamp Response procedure; an RTCP Sender and Receiver Report with delay of last sender report marking procedure; and/or an RTP PDU timestamps piggybacking procedure by means of at least one of RTP header extensions and RTP payload.

The data collection client may comprise a media session handler (MSH).

The link delay measurements may be based on at least one of: an interval-based collection, whereby a measurement is collected with a configured sampling frequency; a threshold-based collection, whereby a measurement is collected if the measurement exceeds a configured threshold value; and/or an event-based collection, whereby a measurement is collected if a configured event is triggered. By way of example, an interval-based data collection may use a sampling frequency of link delay measurements of 500 milliseconds. Byway of further example, a threshold-based data collection may use a link delay threshold of 20 milliseconds for which any link delay rising over the threshold generates a collection of link delay measurement data. In another example, an event-based data collection may use a tethered session establishment or update event such that when triggered by the event link delay measurement data is collected.

The method link delay performance event may comprise an indication of at least one of: a link delay performance of a tethered connection; a link delay performance of an end-to-end link; and a link delay performance of a data network link. The end-to-end link is the link between one of the first device and the second device and one of an application server and an edge application server. The data network link is the link between a PDU session anchor user plane function (PSA UPF) and one of the application servers and the edge application server.

The indication may include an aggregation filter applied over a configured aggregation window wherein the aggregation filter is based on at least one of: an average operation of the collected link delay performance measurements collected over the duration of the aggregation window; a maximum operation of the collected link delay performance measurements collected over the duration of the aggregation window; and/or a counting operation of the collected link delay performance measurements collected over the duration of the aggregation window.

Accordingly, there is provided a method for collecting, reporting, and exposing delay metrics as novel Event IDs in the context of 5GS Service Based Architecture (SBA) for link performance analytics of immersive and interactive applications (e.g., XR applications) experienced by end users over a tethered UE under challenging requirements for the E2E delay budget. The novel Event IDs map to the tethered link delay performance, DN link delay performance and E2E link delay performance and can be accessed upon ASP AF request.

There is further provided a method for exposure of link delay performance events for an application experienced over a tethered user equipment (UE), the method comprising; provisioning the tethered UE and a data collection application function (DCAF) with a configuration for a data access profile for data collection; applying the data access profile configuration to one or more data collection clients for link delay measurements data collection; collecting one or more link delay measurements for the application including the tethered UE at the one or more data collection clients based in part on the data access profile; reporting the collected link delay measurements to the DCAF; processing the link delay measurements at the DCAF based in part on the data access profile to produce one or more link delay performance events; and exposing from the DACF link delay performance events corresponding to the application experienced over the tethered UE.

The tethered UE may be formed of at least one tethered device and a tethering device providing connectivity access to a data network hosting at least one of an application server and an edge application server corresponding to the application.

The one or more data collection clients may be represented by at least one of: a direct data collection client (DDCC) as a logical component of the tethered UE; a data collection client as a logical component at the application server; and a data collection client at a logical component at the edge application server.

The method may further comprise determining the delay measurements by at least on of in-band, out-of-band, end-to-end and segment-by-segment delay measuring procedures relative to the application traffic.

The delay measuring procedure may include at least one of: an Internet Control Message Protocol (ICMP) Echo Reply procedure; an ICMP Timestamp Request and ICMP Timestamp Response procedure; an RTCP Sender and Receiver Report with delay of last sender report marking procedure; and an RTP PDU timestamps piggybacking procedure by means of at least one of RTP header extensions and RTP payload.

The DDCC may be a part of media session handler (MSH).

The data collection client configuration may comprise collecting link delay measurements based at least on one of: an interval-based collection, whereby a measurement is collected with a configured sampling frequency; a threshold-based collection, whereby a measurement is collected if the measurement exceeds a configured threshold value; and an event-based collection, whereby a measurement is collected if a configured event is triggered.

Each of one or more link delay performance events may comprise an indication of at least one of: a link delay performance of a tethering link, wherein the tethering link is between the tethered device and the tethering device of the tethered UE; a link delay performance of an end-to-end link, wherein the end-to-end link is the link between the tethered device and one of the application server and the edge application server; and a link delay performance of a data network link, wherein the data network link is the link between the PDU session anchor user plane function (PSA UPF) and one of the application server and the edge application server.

The indication may include an aggregation filter applied over a configured aggregation window wherein the aggregation filter is based on at least one of: an average operation of the collected link delay performance measurements collected over the duration of the aggregation window; a maximum operation of the collected link delay performance measurements collected over the duration of the aggregation window; and a counting operation of the collected link delay performance measurements collected over the duration of the aggregation window.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms.

The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5G, fifth generation; 5GS, 5G System; 5QI, 5G QoS Identifier; A-ADRF, application layer analytics data repository function; ADAEC, application data analytics enablement client; ADAES, application data analytics enablement server; A-DCCF, application layer data collection and coordination function; AF, application function; AMF, access and mobility function; AR, augmented reality; AS, application server; ASP, application service provider; DCAF, data collection AF; DL, downlink; EAS, edge application server; NAL, network abstraction layer; NRM, network resource management; PCF, policy control function; PDU, packet data unit; PPS, picture parameter set; PSA UPF, PDU session anchor UPF; PSB, PDU set boundary; PSI, PDU set importance; QoE, quality of experience; QoS, quality of service; RAN, radio access network; RTCP, real-time control protocol; RTP, real-time protocol; SDAP, service data adaptation protocol; SEAL, service enablement application layer; SMF, session management function; SRTCP, secure real-time control protocol; SRTP, secure real-time protocol; UE, user equipment; UL, uplink; UPF, user plane function; VAL, vertical application layer; VCL, video coding layer; VMAF, video multi-method assessment function; VPS, video parameter set; VR, virtual reality; XR, extended reality; XR AS, XR application server; and XRM, XR media.

1. A network node for wireless communication, comprising:
a data collection application function for exposure of link delay performance events for an application experienced via a tethered connection between a first device and a second device;
at least one memory; and
at least one processor coupled with the at least one memory and configured to cause the data collection application function to:
receive a configuration for a data access profile for data collection, the data associated with a link delay in the tethered connection;
apply the data access profile to at least one data collection client;
receive link delay measurements from the at least one data collection client;
process the link delay measurements based in part on the data access profile to produce one or more link delay performance events; and
expose the one or more link delay performance events corresponding to the application experienced via the tethered connection.

2. The network node comprising the data collection application function of claim 1, wherein one of:
the first device is a tethering deviceand the second device is a tethered device;
the first device is the tethered device and the second device is the tethering device.

3. (canceled)

4. The network node comprising the data collection application function of claim 1, wherein the first device and the second device are arranged to provide connectivity access to a data network hosting at least one of an application server or an edge application server corresponding to the application.

5. The network node comprising the data collection application function of claim 1, wherein the at least one data collection client comprises at least one of:
a direct data collection client as a logical component of at least one of the first device or the second device;
the at least one data collection client as the logical component at an application server corresponding to the application; or
the at least one data collection client as the logical component at an edge application server corresponding to the application.

6. The network node comprising the data collection application function of claim 1, wherein the link delay measurements are obtained by at least one of in-band, out-of-band, end-to-end, or segment-by-segment delay measuring procedures.

7. The network node comprising the data collection application function of claim 1, wherein the link delay measurements are obtained by a measuring procedure comprising at least one of:
an Internet Control Message Protocol (ICMP) Echo Reply procedure;
an ICMP Timestamp Request and ICMP Timestamp Response procedure;
an RTCP Sender and Receiver Report with delay of last sender report marking procedure; or
an RTP PDU timestamps piggybacking procedure by means of at least one of RTP header extensions and RTP payload.

8. The network node comprising the data collection application function of claim 1, wherein the at least one data collection client comprises a media session handler (MSH).

9. The network node comprising the data collection application function of claim 1, wherein the link delay measurements are based on at least one of:
an interval-based collection, whereby a measurement is collected with a configured sampling frequency;
a threshold-based collection, whereby a measurement is collected if the measurement exceeds a configured threshold value; or
an event-based collection, whereby a measurement is collected if a configured event is triggered.

10. The network node comprising the data collection application function of claim 1, wherein a link delay performance event comprises an indication of at least one of:
a link delay performance of the tethered connection;
a link delay performance of an end-to-end link between one of the first device or the second device and one of an application server or an edge application server; or
a link delay performance of a data network link between a PDU session anchor user plane function (PSA UPF) and one of the application server or the edge application server.

11. The network node comprising the data collection application function of claim 10, wherein the indication includes an aggregation filter applied over a configured aggregation window, wherein the aggregation filter is based on at least one of:
an average operation of collected link delay performance measurements collected over a duration of the configured aggregation window;
a maximum operation of the collected link delay performance measurements collected over the duration of the configured aggregation window; or
a counting operation of the collected link delay performance measurements collected over the duration of the configured aggregation window.

12. A method performed by a data collection application function, the method for exposure of link delay performance events for an application experienced via a tethered connection between a first device and a second device, the method comprising;
receiving a configuration for a data access profile for data collection, the data associated with a link delay in the tethered connection;
applying the data access profile to at least one data collection client;
receiving link delay measurements from the at least one data collection client;
processing the link delay measurements based in part on the data access profile to produce one or more link delay performance events; and
exposing the one or more link delay performance events corresponding to the application experienced via the tethered connection.

13. A data collection client for exposure of link delay performance events for an application experienced via a tethered connection between a first device and a second device, the data collection client comprising;
at least one memory; and
at least one processor coupled with the at least one memory and configured to cause the data collection client to:
receive a data access profile from a data collection application function;
collect link delay measurements in accordance with the received data access profile; and
send collected link delay measurements to the data collection application function.

14. The data collection client of claim 13, wherein one of:
the first device is a tethering device and the second device is a tethered device; or
the first device is the tethered device and the second device is the tethering device.

15. (canceled)

16. The data collection client of claim 13, wherein the data collection client is comprised within at least one of the first device, the second device, or an application service provider device.

17. The data collection client of claim 13, wherein the first device and the second device are arranged to provide connectivity access to a data network hosting at least one of an application server or an edge application server corresponding to the application.

18. The data collection client of claim 13, wherein the data collection client comprises at least one of:
a direct data collection client as a logical component of at least one of the first device or the second device;
the data collection client as the logical component at an application server corresponding to the application; or
the data collection client as the logical component at an edge application server corresponding to the application.

19. The data collection client of claim 13, wherein the link delay measurements are obtained by at least one of in-band, out-of-band, end-to-end, or segment-by-segment delay measuring procedures.

20. The data collection client of claim 13, wherein the link delay measurements are obtained by a measuring procedure comprising at least one of:
an Internet Control Message Protocol (ICMP) Echo Reply procedure;
an ICMP Timestamp Request and ICMP Timestamp Response procedure;
an RTCP Sender and Receiver Report with delay of last sender report marking procedure; or
an RTP PDU timestamps piggybacking procedure by means of at least one of RTP header extensions and RTP payload.

21. The data collection client of claim 13, wherein the data collection client comprises a media session handler (MSH).

22-24. (canceled)

25. A method performed by a data collection client, the method for exposure of link delay performance events for an application experienced via a tethered connection between a first device and a second device, the method comprising;
receiving a data access profile from a data collection application function;
collecting link delay measurements in accordance with the received data access profile; and
sending collected link delay measurements to the data collection application function.
